(19) United States
(12) Patent Application Publication
(10) Pub. No.: US 2017/0033445 A1
(43) Pub. Date: Feb. 2, 2017

(54) TERMINAL DEVICE

(71) Applicant: SHARP KABUSHIKI KAISHA, Sakai City (JP)

(72) Inventors: Yusuke OKAJIMA, Sakai City (JP); Hiroyuki TAKEBE, Sakai City (JP)

(21) Appl. No.: 15/303,565

(22) PCT Filed: Apr. 14, 2015
(86) PCT No.: PCT/JP2015/061455

§ 371 Date: Oct. 12, 2016

(30) Foreign Application Priority Data
Apr. 30, 2014 (JP) 2014-093835

(51) Int. Cl. H01Q 1/24; H04B 1/3818

(52) U.S. Cl. CPC H01Q 1/243; H04B 1/3818

(57) ABSTRACT

In the present invention, a metallic section (22) has an opening (21). An antenna 6 is provided in a terminal device 1, in a location overlapped with the opening 21 when the opening (21) is viewed from an opening surface of the opening (21). The metallic section (22) has the opening (21) such that the metallic section (22) includes a notch-like shape when the opening (21) is viewed from the opening surface, the notch-like shape being cut out from a side of the metallic section which side is closer to the antenna (6). This ensures body rigidity while also enabling the antenna to exhibit favorable properties during use of the terminal device (1) by a user.

### TECHNICAL FIELD

The present invention relates to a terminal device with an antenna.

### BACKGROUND ART

Recent years have seen the popularization of various mobile terminals which can be operated while being held by a user and which also have a radio communication function. The majority of such mobile terminals include both (i) an antenna, therein, for radio communication and (ii) an external metal housing for protecting internal components of the mobile terminal. Such a configuration, however, causes a problem that the external metal housing leads to deterioration in properties of the antenna. Some conventional arts have attempted to solve such a problem.

Patent Literature 1 discloses a mobile terminal device configured to include an external housing made up at least partially by a metal housing 3 made from a metal material, an antenna 42 provided on a circuit board, and an operation unit provided on the external housing so as to overlie the antenna. With the configuration of Patent Literature 1, the mobile terminal device can improve communication performance while ensuring adequate rigidity of the external housing.

### CITATION LIST

### Patent Literature

[Patent Literature 1]

Japanese Patent Application Publication Tokukai No. 2010-136017 (Publication date: Jun. 17, 2010)

### SUMMARY OF INVENTION

### Technical Problem

While a user is using the mobile terminal device of Patent Literature 1, the user's finger etc. touches the operation unit, which is located to overlie the antenna. This causes the user's finger to block radio waves, and thereby causes, while the user is using the device, the problem of deterioration in properties of the antenna of the mobile terminal device of Patent Literature 1.

A terminal device in accordance with the present invention was made in view of the above problem. An objective of the present invention lies in providing a terminal device that has favorable properties of an antenna, while ensuring body rigidity, even in a case where a user uses the terminal device.

### Solution to Problem

In order to solve the above problem, a terminal device in accordance with the present invention includes: an insertion section into which a removable component is to be inserted; an external housing including a metallic section having an opening, the opening allowing for insertion of the removable component into the insertion section; and an antenna provided in the terminal device, at least a part of the antenna being located to overlap with the opening when the opening is viewed from an opening surface of the opening, the metallic section having the opening such that the metallic section includes a notch-like shape when the opening is viewed from the opening surface, the notch-like shape being cut out from a side of the metallic section which side is closer to the antenna.

### Advantageous Effects of Invention

One embodiment of the present invention brings about the advantageous effect of having favorable properties of an antenna, while ensuring body rigidity, even in a case where a user uses the terminal device.

### BRIEF DESCRIPTION OF DRAWINGS

FIG. 1 is a diagram illustrating a configuration of main components of a terminal device in accordance with

Embodiment 1 of the present invention, as well as an exterior of the terminal device.

FIG. 2 is a diagram illustrating a state in which a cover has been fitted in the opening of the terminal device in accordance with Embodiment 1 of the present invention.

FIG. 3 is a diagram illustrating a second arrangement example of an antenna of the terminal device in accordance with Embodiment 1 of the present invention.

FIG. 4 is a diagram illustrating a third arrangement example of the antenna of the terminal device in accordance with Embodiment 1 of the present invention.

FIG. 5 is a diagram illustrating a fourth arrangement example of the antenna of the terminal device in accordance with Embodiment 1 of the present invention.

FIG. 6 is a diagram illustrating a configuration of internal parts of a terminal device in accordance with Embodiment 2 of the present invention.

### DESCRIPTION OF EMBODIMENTS

### Embodiment 1

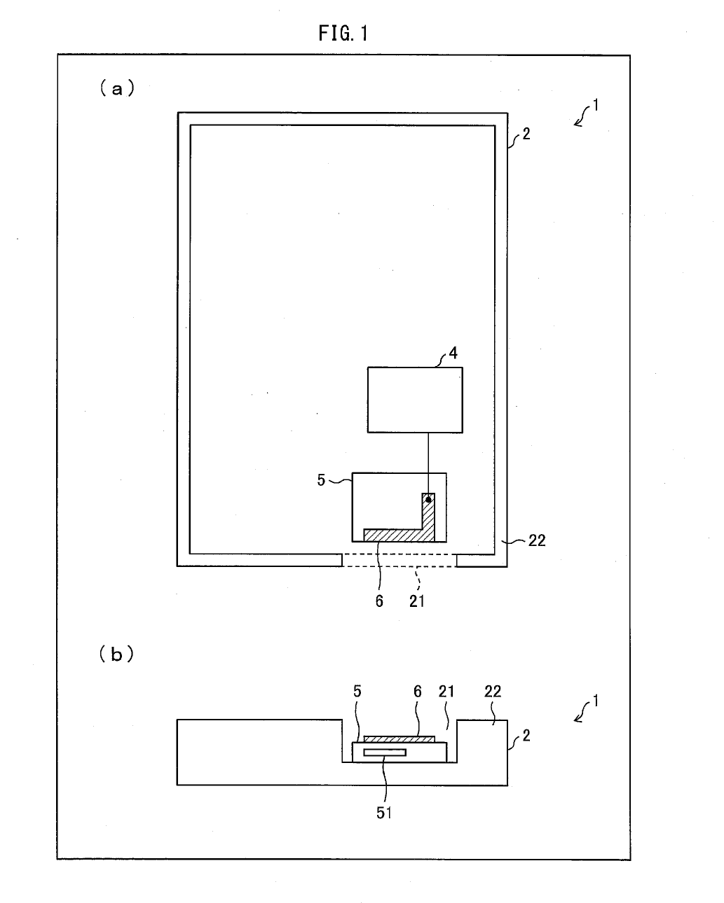

The following description will discuss Embodiment 1 in accordance with the present invention with reference to FIGS. 1 through 5.

FIG. 1 is a diagram illustrating a configuration of main components of a terminal device 1 in accordance with Embodiment 1 of the present invention, as well as an exterior of the terminal device 1. As illustrated in (a) of FIG. 1, the terminal device 1 includes an external housing 2, a communication circuit 4, a SIM (Subscriber Identify Module) slot 5, and an antenna 6.

The terminal device 1 can (i) be operated while being held by a user and (ii) communicate via a radio signal. The terminal device 1 can be realized by, for example, a mobile phone, a smartphone, or a tablet-type terminal. The terminal device 1 can make a radio communication, via the Internet, with another communication device (for example, a server) by sending and receiving a radio signal through the antenna 6 provided in the terminal device 1.

The external housing 2 includes a metallic section 22 having an opening 21. The metallic section 22 is made from a metal material and is provided, in the form of a frame, along the periphery of the terminal device 1. The metallic section 22 serves a role of giving high rigidity to the outer surface of the terminal device 1. Even in a case where a large external force is applied to the terminal device 1, such as a case where the terminal device 1 falls to the ground, the external housing 2 absorbs the external force, thereby absorbing the impact on internal components of the terminal device 1.

Internal components for carrying out various functions of the terminal device 1 are provided in the terminal device 1. Hereinafter, internal components, which are not necessary for describing the terminal device 1 in accordance with Embodiment 1, are omitted from descriptions and drawings. FIG. 1 only illustrates the communication circuit 4, the SIM slot 5, and the antenna 6 as examples of internal components.

The communication circuit 4 is an electronic circuit that handles a radio communication in the terminal device 1. The communication circuit 4 sends and receives wireless signals via the antenna 6, which is a radio communication antenna connected to the communication circuit 4 via an antenna feed point.

The SIM slot 5 (insertion section) is provided, on an upper end of the terminal device 1, for insertion of a SIM card (removable component) into the terminal device 1. As illustrated in (b) of FIG. 1, The SIM slot 5 has an insertion opening 51 allowing for insertion of the SIM card. While a SIM card is inserted into the insertion opening 51, the terminal device 1 can make a radio communication via a prescribed telecommunications carrier.

As illustrated in (a) and (b) of FIG. 1, the metallic section 22 has an opening 21 for insertion of a SIM card into the SIM slot 5. The metallic section 22 has the opening 21 which is located such that the metallic section 22 includes a notch-like shape, when the opening 21 is viewed from an opening surface of the opening 21 (as illustrated in (b) of FIG. 1). The notch-like shape is obtained by cutting out from a side of the metallic section 22 which side is closer to the antenna 6. The opening 21 has a size not less than that of a lateral surface of the SIM slot 5 such that a SIM card can be inserted into and removed from the SIM slot 5. The opening 21 is located to overlap with the SIM slot 5 in the terminal device 1 when the opening 21 is viewed from an opening surface of the opening 21. As illustrated in (b) of FIG. 1, the user is able to see the SIM slot 5 through the opening 21.

As illustrated in (b) of FIG. 1, the antenna 6 is provided, in the terminal device 1, on an upper surface (back surface) of the SIM slot 5. That is, the antenna 6 is provided on a top end of the terminal device 1, which top end has the opening 21. The entirety of the antenna 6 is located to overlap with the opening 21 when the opening 21 is viewed from the opening surface of the opening 21. That is, the antenna 6 is located to be completely within the width of the opening 21. A feed side of the antenna 6 is electrically connected to the communication circuit 4.

Note that “a location where the opening 21 is overlapped when the opening 21 is viewed from the opening surface of the opening 21” may also simply be referred to as “a location overlapped with the opening 21.”

As described above, the terminal device 1 in accordance with Embodiment 1 includes the metallic section 22 and thus has adequate rigidity. Furthermore, the antenna is provided, in the terminal device 1, in a location overlapped with the opening 21 (i.e., the notch-like shaped part of the metallic section 22 in which no metal exists) through which the SIM card is inserted into and removed from the SIM slot 5. This makes it possible to ensure an adequate distance between the antenna 6 and the metallic section 22, thereby making it possible to achieve favorable antenna properties of the terminal device 1. That is, the terminal device 1 possesses both adequate body rigidity and favorable properties of the antenna 6.

Note also that in the terminal device 1, the antenna 6 is not provided near an operation section for operating the terminal device 1. Because of this, the antenna 6 will not be covered or blocked by a user's finger etc. while the user is operating the terminal device 1. This makes it possible to achieve both rigidity of the terminal device 1 and favorable 78 ies of the antenna 6 while the user is using the terminal device 1.

It should be noted that the opening 21 is inherently necessary in the terminal device 1 in order to provide the SIM slot 5 and, as such, is not additionally provided to the external housing 2 for enhancing the properties of the antenna 6. That is, the terminal device 1 makes it possible to maintain a normal design of the device, because there is no need to provide a special opening in the external housing 2 for enhancing the properties of the antenna 6.

As illustrated in FIG. 1, the entirety of the antenna 6, including the tip and the feed side of the antenna 6, is provided on top of the SIM slot 5. That is, the entirety of the antenna 6 is provided within a location overlapped with the opening 21. This renders the entirety of the antenna 6 less likely to be affected by the metallic section 22. As such, the terminal device 1 in accordance with Embodiment 1 enables more favorable properties of the antenna 6, in comparison with a configuration in which merely one part of the antenna 6 is in a location overlapped with the opening 21.

A tip-side part of the antenna 6 exhibits better sensitivity to radio waves in comparison with a feed-side part of the antenna 6. As such, in a case where a part of the antenna 6 is provided in a location overlapped with the opening 21, it is preferable that the tip-side part of the antenna 6, rather than the feed-side part, is provided in a location overlapped with the opening 21. It is preferable that a part of the antenna 6 corresponding to λ/8 of the entire length of the antenna 6 is provided in a location overlapped with the opening 21. Note here that A is a wavelength corresponding to an operating frequency of the antenna 6.

The closer the antenna 6 is to an end of the terminal device 1, the less likely the antenna 6 is to be affected by other internal components in the terminal device 1. This makes it possible to achieve more favorable properties of the antenna 6. As such, it is preferable to provide the antenna 6 in a location as close as possible to the opening 21. It is more preferable to provide the antenna 6 such that the tip-side part thereof is in a location no more than λ/16 away from the opening 21. This is because the antenna 6 will be almost unaffected by the metallic section 22 in such a location.

Note that the location of the antenna 6 in the terminal device 1 is not necessarily limited to being a location overlapped with the opening 21. The antenna 6 needs only be provided on any surface of any insertion section for inserting any removable component, the insertion section being provided in the terminal device 1, provided that an opening is provided in a location on the external housing 2 corresponding to the insertion section, the opening giving the metallic section 22 a notch-like shape cut out from a side of the metallic section 22 closer to the antenna 6. Examples of such an insertion section encompass a jack, an SD card slot, or a USB memory slot.

### (Use of Cover 7)

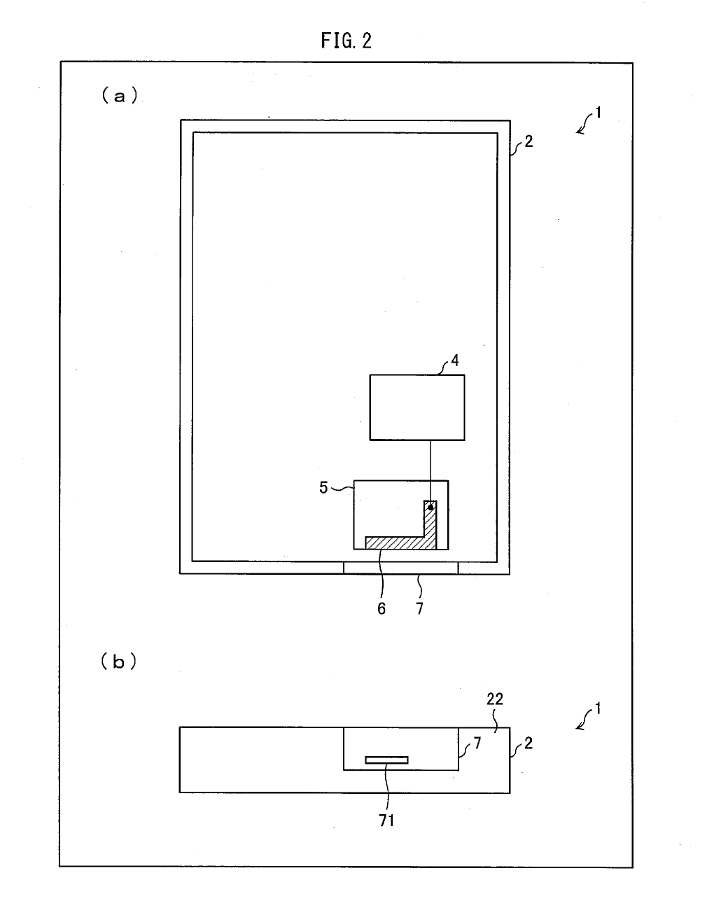

A cover 7 that enables covering/exposing of the opening 21 can be further fitted on the external housing 2 in order to protect the inside of the terminal device 1. FIG. 2 is a diagram illustrating the terminal device 1 in a state in which the cover 7 is fitted on the external housing 2. The cover 7 is made from an insulative material such as a resin. As illustrated in (b) of FIG. 2, the cover 7 has an insertion opening 71 provided in a location corresponding to the insertion opening 51 of the SIM slot 5. Even in a case where the cover 7 is fitted on the external housing 2, the user can insert a SIM card into the insertion opening 51 of the SIM slot 5 through the insertion opening 71.

Because the cover 7 is an insulator, radio waves sent or received via the antenna 6 will not be blocked by the cover 7 even in a case where the opening 21 is covered by the cover 7. As such, the antenna 6 will keep favorable properties even while the cover 7 is fitted on the terminal device 1.

Note that the cover 7 can alternatively be made from a conductive material such as a metal. In such a case, the cover 7 must not come into direct contact with the external housing 2 while fitted thereon. For example, in a case where the cover 7 is made of metal, a resin frame can be further provided around the cover 7 such that the resin frame is in contact with the external housing 2 while the cover 7 is fitted in the opening 21 of the external housing 2. With such a configuration, the resin frame will not interfere with sending/receiving of radio waves via the antenna 6, thereby making it possible to maintain favorable properties of the antenna 6.

The size of the opening 21 in the external housing 2 can be controlled by adjusting the size of the cover 7. The properties of the antenna 6 can be further improved by making the opening 21 to be larger than the SIM slot 5, i.e., by making a cutout in the notch-shaped portion (portion with no metal) of the metallic section 22 to be larger than the SIM slot 5. Doing so will not negatively affect the design of the terminal device 1, because the large opening 21 can be hidden by the cover 7.

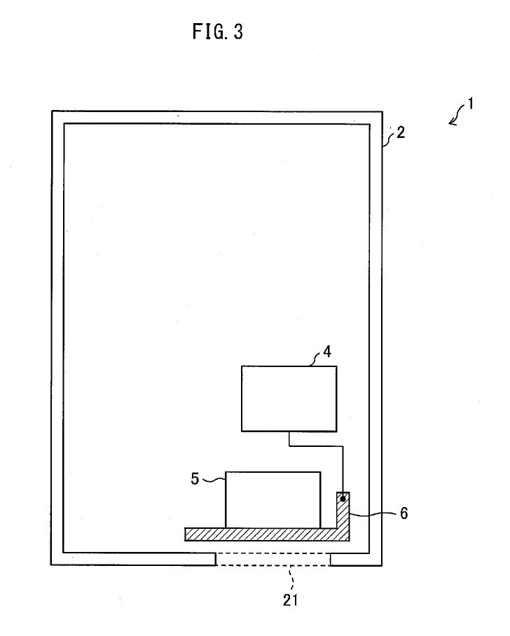

The location of the antenna 6 in the terminal device 1 in accordance with Embodiment 1 is not limited to that shown in FIG. 1. As long as at least a part of the antenna 6 is in a location overlapped with the opening 21, it is possible to achieve favorable properties of the antenna 6. The following discussion will describe three different examples of arrangement of the antenna 6, with reference to FIGS. 3 through 6.

(Second Arrangement Example of Antenna 6)

FIG. 3 is a diagram illustrating a second arrangement example of the antenna 6 of the terminal device 1 in accordance with Embodiment 1 of the present invention. In the terminal device 1 illustrated in FIG. 3, only part of the antenna 6 is provided in a location overlapped with the opening 21. Neither the tip nor the feed-side portion of the antenna 6 is in a location overlapped with the opening 21. Note, however, that a central part of the antenna 6 is provided in a location overlapped with the opening 21. This causes a reduction in the effect of the metallic section 22 on the central part of the antenna 6, thereby enabling favorable properties of the antenna 6.

(Third Arrangement Example of Antenna 6)

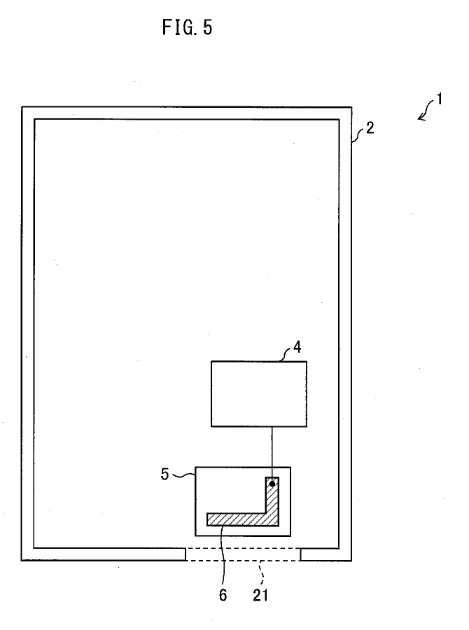

FIG. 5 is a diagram illustrating a third arrangement example of the antenna 6 of the terminal device 1 in accordance with Embodiment 1 of the present invention. In the terminal device 1 illustrated in FIG. 5, the antenna 6 is provided not at an end part of the terminal device 1, but rather in an internal area of the terminal device 1, a certain distance away from the end part. This configuration is similar to that of FIG. 1 in that the antenna 6 is provided entirely in a location overlapped with the opening 21. Even in the configuration, the opening 21 (i.e., the cutout in the notch-shaped portion) is in the vicinity of the antenna 6, thus ensuring a distance between the antenna 6 and the metallic section 22. This makes it possible to achieve favorable properties of the antenna 6.

(Fourth Arrangement Example of Antenna 6)

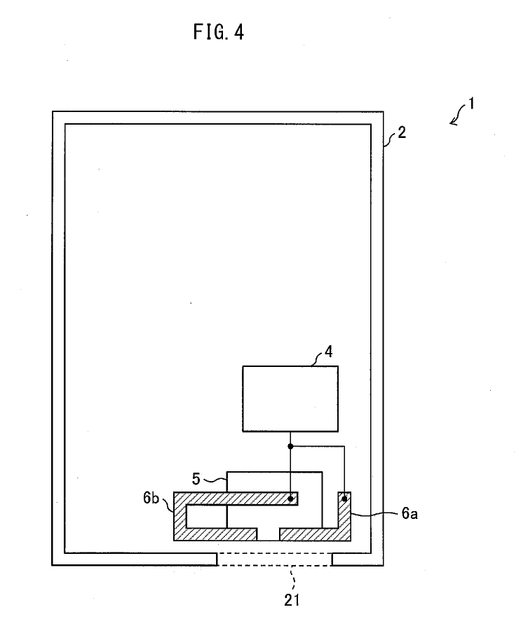

FIG. 4 is a diagram illustrating a fourth arrangement example of the antenna 6 of the terminal device 1 in accordance with Embodiment 1 of the present invention. The terminal device 1 illustrated in FIG. 4 includes two antennas 6a and 6b. The antenna 6a and the antenna 6b respectively handle, for example, an 800 MHz band and a 2 GHz band. Antenna 6a has a length differing from that of antenna 6b.

The antenna 6a is provided such that a tip portion thereof is located on an upper-end-side of the terminal device 1. A part of the tip portion of the antenna 6a is provided in a location overlapped with the opening 21. The antenna 6a is electrically connected to the communication circuit 4, via an antenna feed point.

Similarly to the antenna 6a, the antenna 6b is provided such that a tip-side portion thereof is located on an upper-end-side of the terminal device 1. A part of the tip-side portion of the antenna 6b is provided in a location overlapped with the opening 21. The antenna 6b is electrically connected to the communication circuit 4, via an antenna feed point.

According to the terminal device 1 illustrated in FIG. 4, at least a part of the antenna 6a and at least a part of the antenna 6b are thus each provided in a location overlapped with the opening 21. Both of the antennas 6a and 6b therefore exhibit favorable properties, as in Embodiment 1.

The number of antennas 6 included in the terminal device 1 is not limited to being one or two. The terminal device 1 can include three or more antennas 6, each having at least one part provided in a location overlapped with the opening 21.

The antenna 6a and the antenna 6b are not limited to being the 800 MHz band antenna and 2 GHz band antenna, respectively, illustrated in FIG. 5 and can therefore be antennas for another frequency band. That is, an antenna included in the terminal device 1 can be for any specific use, as long as it is an antenna for wireless communication.

Furthermore, the antenna 6a and the antenna 6b can each be connected to a differing communication circuit, rather than to the communication circuit 4.

### Embodiment 2

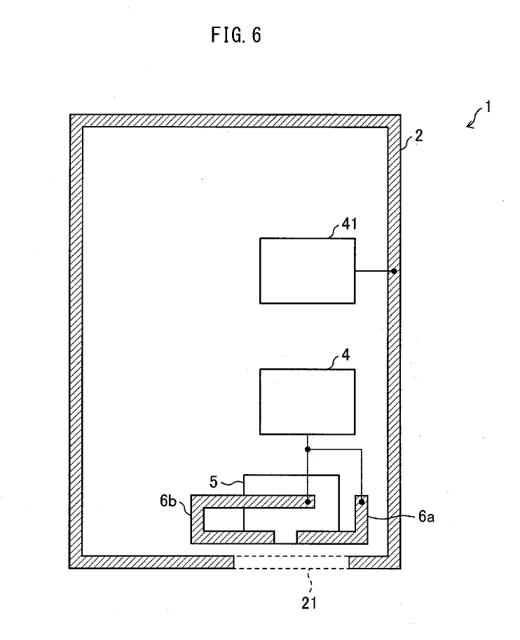

The following description will discuss Embodiment 2 in accordance with the present invention with reference to FIG. 6. Note that members equivalent to those of Embodiment 1 above have been given identical reference symbols, and detailed descriptions thereof will be omitted.

FIG. 6 is a diagram illustrating a configuration of internal components of a terminal device 1 in accordance with Embodiment 2 of the present invention. As illustrated in FIG. 6, the terminal device 1 in accordance with Embodiment includes, in addition to the various members of the terminal device 1 illustrated in FIG. 5, a second communication circuit 41 differing from the communication circuit 4. Note also that, in contrast to the terminal device of FIG. 5, the metallic section 22 of the terminal device 1 of Embodiment 2 functions as a second antenna differing from antennas 6a and 6b. In FIG. 6, the fact that the metallic section 22 functions as the second antenna is represented by diagonal hatching of the metallic section 22, in the same manner as antennas 6a and 6b.

In the terminal device 1 of Embodiment 2, two antennas 6a and 6b are electrically connected, as a first antenna, to the communication circuit 4. Meanwhile, the metallic section 22 is electrically connected to the second communication circuit 41 so as to function as the second antenna. The antennas 6a and 6b are provided in a location overlapped with the opening 21 of the notch-shaped portion of the metallic section 22. This makes it possible to ensure a certain distance between (i) the antennas 6a and 6b and (ii) the metallic section 22. As a result, it becomes possible to control radio wave interference occurring between (i) the antenna 6a and 6b (the first antenna) and (ii) the metallic section 22 (the second antenna). It is therefore possible, with Embodiment 2, to achieve favorable properties of the antennas 6a and 6b, as well as of the metallic section 22 serving as the second antenna.

Note that the antennas 6a and 6b and the metallic section 22 (the second antenna) are not limited to being connected to differing communication circuits and can, alternatively, all be connected to the same communication circuit 4 or 41.

[Recapitulation]

A terminal device according to Aspect 1 of the present invention is a terminal device including: an insertion section (SIM slot 5) into which a removable component (SIM card) is to be inserted; an external housing including a metallic section having an opening, the opening allowing for insertion of the removable component into the insertion section; and an antenna provided in the terminal device, at least a part of the antenna being located to overlap with the opening when the opening is viewed from an opening surface of the opening, the metallic section having the opening such that the metallic section includes a notch-like shape when the opening is viewed from the opening surface, the notch-like shape being cut out from a side of the metallic section which side is closer to the antenna.

With the above configuration, the terminal device includes the external housing having the metallic section and thus has adequate rigidity. Furthermore, in the terminal device, at least a part of the antenna is provided in a location overlapped with the opening, thereby making it possible to ensure a certain distance between the antenna and the metallic section. This makes it possible to achieve favorable antenna properties of the terminal device. That is, the terminal device possesses both adequate body rigidity and favorable properties of the antenna.

Furthermore, in the terminal device, the antenna is not provided near an operation section for operating the terminal device. Because of this, the antenna will not be covered or blocked by a user's finger etc. while the user is operating the terminal device. This makes it possible to achieve favorable properties of an antenna, while ensuring body rigidity, even in a case where a user uses the terminal device.

In Aspect 2 of the present invention, the terminal device of Aspect 1 is preferably arranged such that the metallic section is provided along a periphery of the terminal device.

The above configuration makes it possible to further improve the rigidity of the terminal device.

In Aspect 3 of the present invention, the terminal device of Aspect 1 or 2 is preferably arranged so as to further include a cover that allows for covering and exposing of the opening.

The above configuration enables protection of the inside of the terminal device.

In Aspect 4 of the present invention, the terminal device of any of Aspects 1 through 3 is preferably arranged such that the entirety of the antenna is located to overlap with the opening when the opening is viewed from the opening surface.

With the above configuration, an effect of the metallic section on the antenna can be reduced, thereby making it possible to achieve more favorable properties of the antenna.

In Aspect 5 of the present invention, the terminal device of any of Aspects 1 through 4 is preferably arranged so as to include an electronic circuit (communication circuit 4, communication circuit 41) to which the metallic section is connected such that the metallic section functions as a second antenna.

The above configuration makes it possible to control radio wave interference between the antenna and the second antenna. This makes it possible to achieve favorable properties of both the antenna and the second antenna.

[Additional Remarks]

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

For example, the metallic section 22 is not limited to being made of metal and can alternatively be made from any conductive material.

Furthermore, the size and shape of the metallic section 22 are not particularly limited.

In the above embodiments, the metallic section 22 is described as being in the form of a frame. Note, however, that the metallic section 22 is not limited to having a form that is unbroken around the entire periphery of the terminal device 1. The metallic section 22 can have a form that is not necessarily unbroken, such as a form having a slit or some other area with no metal. Furthermore, the metallic section 22 is not necessarily limited to being in the form of a frame and can constitute the entirety of the external housing 2 or a part of the external housing.

The antenna 6 is not limited to being provided on an upper surface of the SIM slot 5 and can be provided, for example, on a side surface of the SIM slot 5. The antenna 6 can be provided on any surface in the terminal device 1, as long as the location of the antenna 6 is overlapped with the opening 21. Furthermore, the antenna 6 is not limited to being an antenna for use in cellular communications and can be any type of antenna used for wireless communications such as GPS (Global Positioning System), WiFi (Wireless Fidelity; registered trademark), and DTV (Digital Television).

The SIM slot 5 is not limited to being provided in an upper end of the terminal device 1 and can be provided, for example, on a side surface of the terminal device 1. The SIM slot 5 can be provided in any location on the terminal device 1 as long as the location allows for (i) provision of an opening (the opening 21 of the metallic section 22) for insertion/removal and (ii) provision of the antenna 6 in a location overlapped with the opening 21 of the metallic section 22.

The opening 21 is not limited to being on a side surface of the metallic section 22, as long as it is a location that allows for (i) providing a notch-shaped portion on the metallic section 22, the notch-shaped portion being cut out from a side of the metallic section 22 closer to the antenna 6, and (ii) provision of the antenna 6 in a location overlaid by the opening 21 of the metallic section 22.

### INDUSTRIAL APPLICABILITY

The present invention can be applied to a variety of terminal devices with an antenna.

### REFERENCE SIGNS LIST

1 Terminal device

2 External housing

4 Communication circuit (electronic circuit)

5 SIM slot (insertion section)

6 Antenna

7 Cover

21 Opening

22 Metallic section

41 Communication circuit (electronic circuit)

51 Insertion opening

71 Insertion opening

1. A terminal device comprising:
an insertion section into which a removable component is to be inserted;
an external housing including a metallic section having an opening, the opening allowing for insertion of the removable component into the insertion section; and
an antenna provided in the terminal device, at least a part of the antenna being located to overlap with the opening when the opening is viewed from an opening surface of the opening,
the metallic section having the opening such that the metallic section includes a notch-like shape when the opening is viewed from the opening surface, the notch-like shape being cut out from a side of the metallic section which side is closer to the antenna.

2. The terminal device as set forth in claim 1, wherein the metallic section is provided along a periphery of the terminal device.

3. A terminal device as set forth in claim 1, further comprising a cover that allows for covering and exposing of the opening.

4. The terminal device as set forth in claim 1, wherein the entirety of the antenna is located to overlap with the opening when the opening is viewed from the opening surface.

5. A terminal device as set forth in claim 1, further comprising an electronic circuit to which the metallic section is connected such that the metallic section functions as a second antenna.
